(19) United States
(12) Patent Application Publication
(10) Pub. No.: US 2005/0278281 A1
(43) Pub. Date: Dec. 15, 2005

(54) Multi-dimensional data editor

(76) Inventors: Frederick E. Samson, Philadelphia, PA (US); Andres Becerra, Ambler, PA (US)

Correspondence Address: FISH & RICHARDSON, P.C., PO BOX 1022, MINNEAPOLIS, MN, 55440-1022, US

(21) Appl. No.: 10/856,274

(22) Filed: May 28, 2004

(51) Int. Cl. G06F 7/00

(52) U.S. Cl. 707/1

(57) ABSTRACT

A method includes obtaining a first position of a first data item in a data table, obtaining a second position of a second data item in the data table, comparing the first position with the second position, inferring a relationship between the first data item and the second data item based upon comparing the first position with the second position, and updating the data table based on the relationship.

### TECHNICAL FIELD

The application relates generally to processing on a digital computer, and more particularly, to a multi-dimensional data editor executed on the digital computer.

### BACKGROUND

Multi-dimensional databases organize data in a manner which is highly conducive for multi-dimensional analysis. Multi-dimensional analysis centers on several data organizational concepts, such as facts and dimensions.

A fact represents an instance of some particular occurrence or event. Facts also include the properties of the event which are all stored within a database. For instance, the query “Did the Northern region of the store sell above $7M in revenues for Product A” represents a fact. Dimensions (also called characteristics) represent an index by which users can access facts according to the value (or values) they want. Values are also known as key figures. For example, sales data could be broken down into the dimensions of Region, Salesperson, and Product. These three dimensions may be organized in a multi-dimensional array.

### SUMMARY

In a general aspect, the application is directed to a method which includes obtaining a first position of a first data item in a data table; obtaining a second position of a second data item in the data table; comparing the first position with the second position; inferring a relationship between the first data item and the second data item based upon comparing the first position with the second position; and updating the data table based on the relationship.

Another aspect is a computer program product which is tangibly embodied in an information carrier. The computer program product is operable to cause a data processing apparatus to obtain a first position of a first data item in a data table; to obtain a second position of a second data item in the data table; to compare the first position with the second position; to infer a relationship between the first data item and the second data item based upon comparing the first position with the second position; and to update the data table based on the relationship.

Any of the above aspects may include one or more of the following features. In one implementation, both the first and second data items comprise multi-dimensional data. The multi-dimensional data item comprises hierarchical data.

One implementation includes associating the first data item with a characteristic. Data items may include any number of relevant information, such as region, product type, salesperson name, and revenue figures. Data items may also include color, size, weight, and serial numbers. An infinite number of relevant information may exist as a data item. Data items may be categorized either as key figures or characteristics.

Key figures represent quantifiable values. Some examples of key figures may include revenue, sales figures, and total number of employees. Characteristics represent a classification of key figures. For example, characteristics may include sales region, salesperson, and product type.

Another implementation infers relationships between the first and second data items horizontally. In another implementation, the relationship may be inferred vertically.

In yet another implementation, the method further includes updating the data table by detecting a boundary between a characteristic column and a key figure column and filling an empty cell located within the characteristic columns with a characteristic. One implementation performs the filling of the empty cell from top to bottom.

Another feature outputs the multi-dimensional data over a network device. Some implementations output the data in eXtensible Markup Language (XML) format. Other implementations may output the data in a different format, such as comma-separate value (CSV) files or in Excel format. Still other implementations may output the data to a local location.

Another aspect is directed to a method for detecting a boundary between a characteristic region and a key figure region. The method includes locating a first column of a data table that contains an empty cell; determining whether a plurality of data items contained within the first column corresponds to numeric data items or corresponds to non-numeric data items; calculating a criterion using the plurality of data items contained within the first column; and determining whether the first column corresponds to a characteristic column or to a key figure column based on the criterion.

In another aspect, a computer program product which is tangibly embodied in an information carrier. The computer program product is operable to cause a data processing apparatus to locate a first column of a data table that contains an empty cell; to determine whether a plurality of data items contained within the first column corresponds to numeric data items or corresponds to non-numeric data items; to calculate a criterion using the plurality of data items contained within the first column; and to determine whether the first column corresponds to a characteristic column or to a key figure column based on the criterion.

Any of the above aspects may include one or more of the following features. In one implementation, the locating of the first column of the data table further includes determining whether the first column represents a last characteristic column of the data table. Another implementation uses the last characteristic column of the data table as the boundary between the characteristic region and the key figure region. In one implementation, the boundary is automatically created. Another feature represents the boundary graphically. Still another feature allows the user to adjust the boundary.

In one implementation, the criterion corresponds to a numeric percentage for the numeric data item. Numeric percentages greater than the numeric threshold trigger the criterion. In another implementation, the criterion corresponds to a non-numeric percentage for the non-numeric data item. Non-numeric percentages greater than the non-numeric threshold trigger the criterion. Numeric and non-numeric thresholds may include any percentage number pre-determined by the end user. In one implementation, the numeric threshold is ten-percent and the non-numeric threshold is twenty-percent.

The numeric percentage is calculated by dividing the number of unique data items contained within the first column by the sum total of data items within the first column. The non-numeric percentage is calculated by dividing the number of unique data items contained within the first column by the sum total of data items within the first column.

The details of one or more features of the invention are set forth in the accompanying drawings and the description below. Other features, objects, and advantages of the invention will be apparent from the description and drawings, and from the claims.

### DESCRIPTION OF THE DRAWINGS

FIG. 1 shows the architecture of a data warehouse.

FIG. 2 models multi-dimensional data using a data cube.

FIG. 3 shows a graphical user interface containing multi-dimensional data.

FIG. 4 is a flowchart of a process for detecting a boundary between a characteristic region and a key figure region.

FIG. 5 is a flowchart for updating and outputting multi-dimensional data.

### DETAILED DESCRIPTION

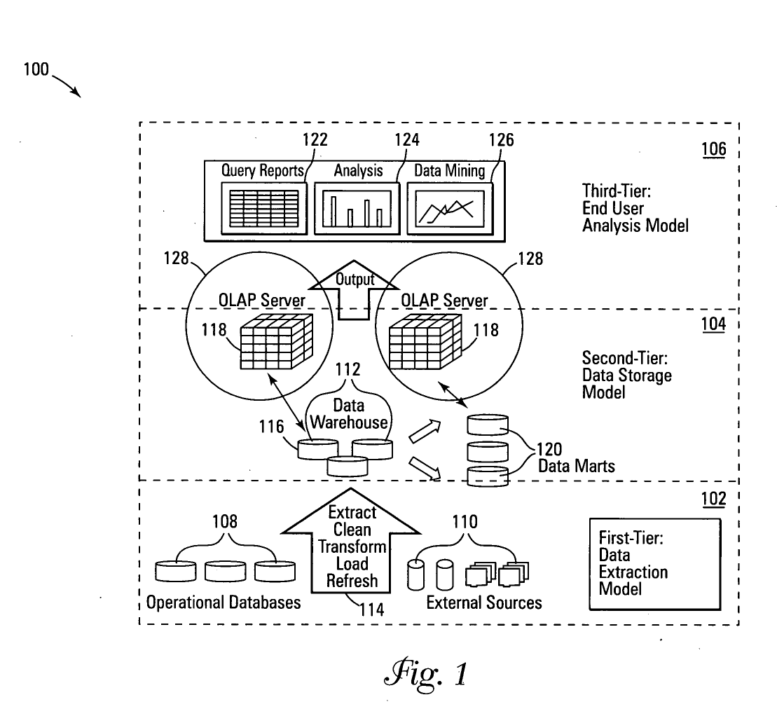

FIG. 1 shows a system for processing and managing multi-dimensional data in data warehouses 112. As shown in FIG. 1, data is extracted and stored multi-dimensionally as hierarchical structures in data warehouses 112. The data is available for analytical processing and use by an end user. Data warehousing of multi-dimensional data may be conceptualized as three-tired data models. As shown in FIG. 1, a first-tier is represented by data extraction model 102.

A second-tier is represented by data storage model 104. The third-tier is represented by end user analysis model 106.

Data extraction model 102 includes a process for extracting data from sources, and for preparing that data for loading into data warehouses 112. In this implementation, data is extracted from operational data stores (or ODS) 108 and external sources 110. ODS 108 is a type of database often used as an interim area for a data warehouse. ODS 108 has the advantage of real-time availability of analytical data. This is because ODS 108 is updated throughout the course of business operations.

Data may also be extracted using file transfers. A file transfer moves data from sources 108 and 110 to data warehouse 112. Other implementations may include using straightforward, customized computer code to extract and move data. In cases where data sources 108 and 110 are built on a relational database, another implementation may include using structured query language (or SQL) for handling data extraction and movement.

Typically, data that is extracted from operational databases 108 and external sources 110 are subjected to process 114, which cleans and prepares the data before loading it into data warehouses 112.

Data storage model 104 shows the storage of the cleaned and prepared data in data warehouses 112. Data warehouses 112 may exist as a single large storage unit 116. Data warehouse 112 may also exist as multiple storage units 120 that contain subsets of the overall data. In this implementation, a class of database-management systems, also known as On-Line Analytical Processors (OLAP) 128, help arrange the extracted data into multi-dimensional data 118 in order to enable high-speed analysis.

End user analysis model 106 supplies analytical functionality to extracted data. In this regard, multi-dimensional data 118 may be exploited by end users in a variety of ways. In one implementation, multi-dimensional data 118 may be used to produce query reports 122. An example of a query report includes a comprehensive listing of monthly sales revenues by company salespersons. Another use of multi-dimensional data 118 involves creating analysis reports 124 which may pinpoint areas that require special attention. One example of an analysis report involves showing the total sales figures for products within a pre-defined region. Still another use of multi-dimensional data is data mining 126. Data mining 126 refers to sophisticated data search capabilities that use statistical algorithms to discover patterns and correlations in the data. Data mining 126 goes beyond basic data analysis 124. Whereas traditional data analysis 124 requires users to decide, in advance, areas of interest, data mining 126 automatically extracts information that users might find significant, such as an unexpected correlation between the sale of two diametrically differing products (e.g., the classic example of the correlation between beer and diaper sales). Other examples of the uses of data mining may include detecting fraud, determining the effectiveness of marketing, and selecting target customers from the general population.

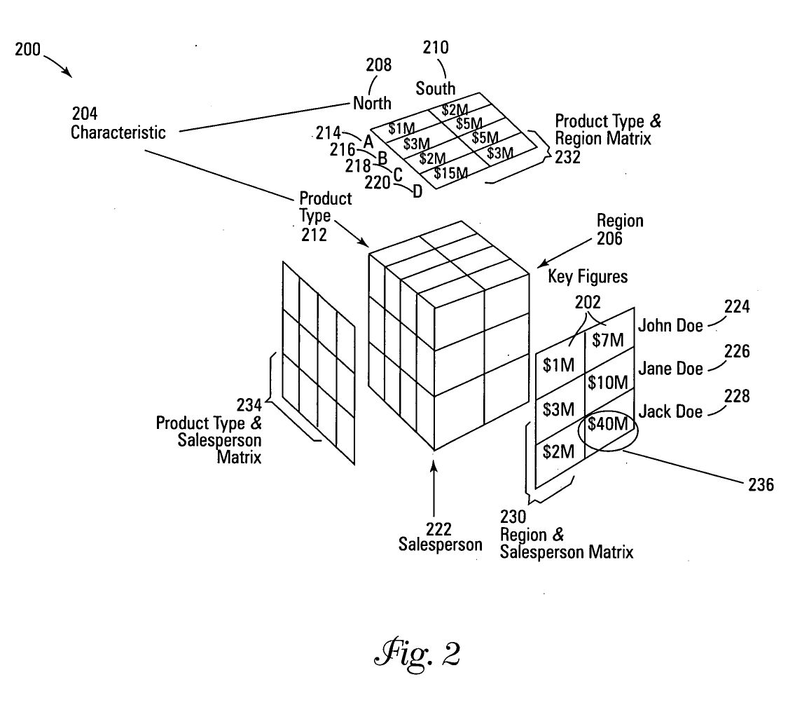

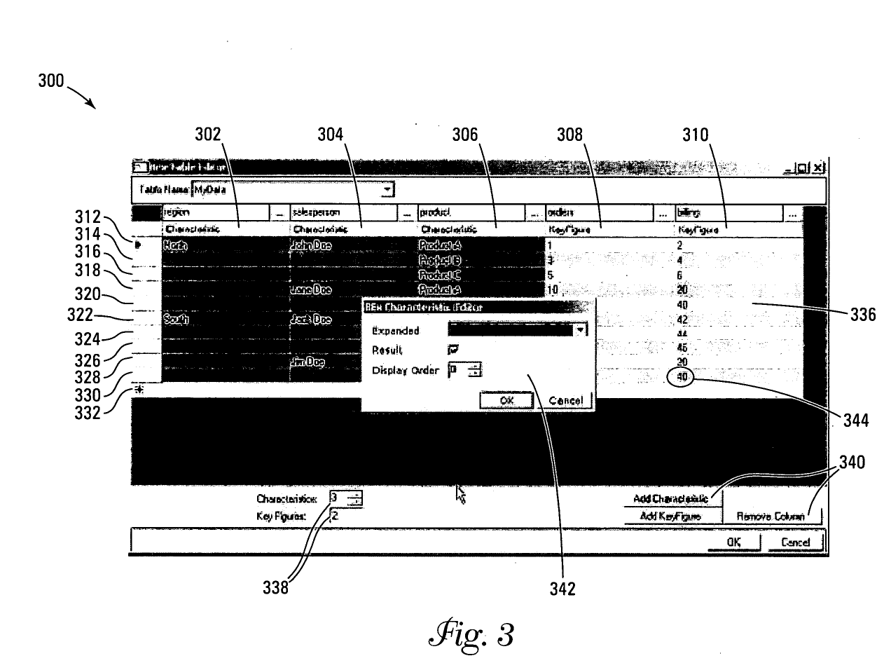

Referring to FIG. 2, multi-dimensional data 118 is modeled by data cube 200. Data cube 200 contains a medley of data items. Data items may refer to any relevant information, such as region 206, product type 212, salesperson name 222, and revenue figures 202 of a product. In other implementations, data items may include color, size, weight, and serial numbers. As shown in FIGS. 2 and 3, data items may be categorized either as key FIGS. 202, 308 or characteristics 204, 302.

Key figures 202 represent quantifiable values. Some examples of key figures 202 may include revenue, sales figures, and total number of employees. Characteristics 204 represent a classification of key figures 202. Examples of characteristics 204 may include sales region, salesperson, and product type. While a data item may be represented as key FIG. 202 in one analytical model, that same data item may be represented as characteristic 204 in another analytical model. The fully interchangeable property of these categories provides greater analytical opportunities for the end user.

Because characteristics 204 contains multi-dimensional layers, each characteristics 204 may be further “drilled down” (which is a term of art meaning to expand a category in order to learn more about a subject) into sub-categories. For example, region characteristic 206 may be drilled down into sub-characteristics “North” 208 and “South” 210. Although not depicted in FIG. 2, North characteristic 208 and South characteristic 210 may be further drilled down. For instance, South characteristic 210 may be drilled down to sub-characteristics of “Southern States”, e.g., Texas, Florida, and Arkansas. These sub-characteristics may be even furthered drilled down to sub-characteristics of cities, e.g., Austin, Dallas, and Houston. In another example, product characteristic 212 may be further drilled down into sub-characteristics of product names: Product A 214, Product B 216, Product C 218, and Product D 220. Another example shows that salesperson characteristic 222 may be further drilled down into the sub-characteristics of salesperson names, e.g. John Doe 224, Jane Doe 226, and Jack Doe 228.

As shown in FIG. 2, two-dimensional matrices 230, 232, 234 are formed by combining any two characteristics 204 of data cube 200. Each box (236) of matrices 230, 232, 234 contains relevant key figures 202 for a particular dimensional axis. For example, matrix 230 (which is formed through the combination of region characteristic 206 and salesperson characteristic 222) illustrates that salesperson Jack Doe 228 had the highest sales revenue of $40M for Southern region 210.

As illustrated in FIG. 2, other matrix combinations may be formed. For example, matrix 232 is created by combining region characteristic 206 and product type characteristic 212. In another example, matrix 234 is created by combining product type characteristic 212 and salesperson characteristic 222.

FIG. 3 shows a graphical user interface which makes up data table 300. Data table 300 is produced by multi-dimensional data editor software (MDE). The MDE also produces editor box (342) which acts as a user interface.

Data table 300 contain a plurality of columns 302, 304, 306, 308, and 310. Data table 300 also contain a plurality of rows 312, 314, 316, 318, 320, 322, 324, 326, 328, 330, and 332. Columns 302, 304, 306 are considered collectively as “characteristic columns” since they are each associated with a characteristic, e.g. Region, Salesperson, Product. For example, column 302 contains data which is associated to “Region” 206, as described in FIG. 2. Similarly, “Salesperson” 222 (FIG. 2) is contained within column 304 of data table 300 (FIG. 3). “Product type” characteristic 212 (FIG. 2) is also contained within column 306 of data table 300 (FIG. 3). In addition, characteristic columns 302, 304, 306 together form characteristic region 334.

Columns 308 and 310 are considered collectively as “key figure columns,” since they each contain key figure data. Key figure columns 308 and 310 correspond to key figure data 202 found in FIG. 2. Key figure columns 308 and 310 together form key figure region 336.

Referring to FIG. 3, although rows 314, 316, 318, 320, 324, 326, 328, 330 appear empty, they each are associated internally with the characteristic located above it. For example, row 314 of column 302 is associated with the characteristic North.

The MDE infers relationships between data items based on the positions of data items relative to each other. Relationships are inferred horizontally between characteristics and key figures. In addition, relationships are inferred vertically between an empty cell and the characteristic located above it.

For example, data item 344 located on row 330 and key figure column 310 is associated horizontally with corresponding region characteristic 302 (e.g. South), salesperson characteristic 304 (e.g. Jim Doe), and product type characteristic 306.

Inserting new row 332 (e.g., using add and removal buttons 340) under row 330 automatically infers a vertical relationship between the above-mentioned characteristics of region 302 (e.g. South), salesperson 304 (e.g. Jim Doe), and product type 306 to the respective cells located within new row 332. This is because new row 332 is located in a position underneath the above characteristics (e.g. South, Jim Doe), and thus a relationship between the above characteristics (e.g. South, Jim Doe) is associated with any key figures contained within new row 332.

In another example, if new row 332 was inserted between row 318 and 320, then based on its new position, new row 332 would be associated with a different set of characteristics, e.g. North, Jane Doe, Product A.

By not explicitly assigning data items to a specific category the MDE provides users with greater flexibility for manipulating data items within data table 300. For example, a user can quickly and easily alter the relationships between various data items by simply reordering the rows or columns from one position to another position within data table 300. In some implementations, reordering may involve dragging with a mouse. In other implementations, reordering may involve using a cut and paste function.

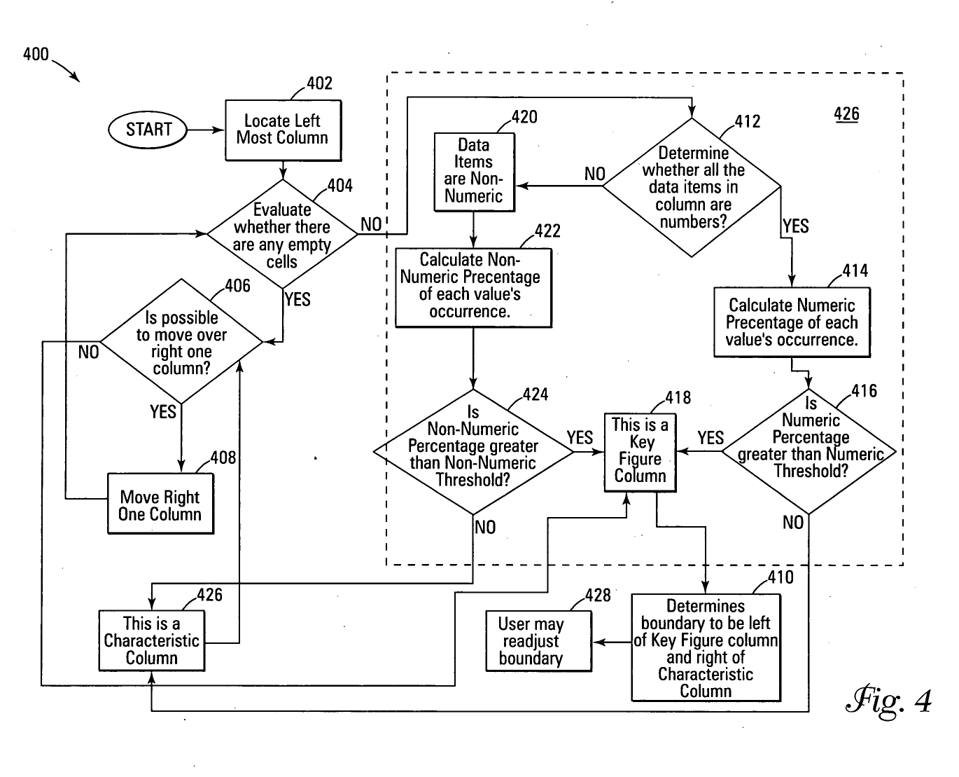

As described below, column 306 represents the last characteristic column. Last characteristic column 306 serves as the boundary between characteristic region 334 and key figure region 336. Column 306 is determined to be the last characteristic column through an analysis performed by automatic process 426, as described below in FIG. 4.

As shown in FIG. 3, status box 338 shows the total number of characteristic columns and key figure columns. For example, in this implementation, there are three characteristic columns and two key figure columns. FIG. 3 also depicts add and remove buttons 340 which allow users to modify data table 300 in accordance with data analysis requirements.

In FIG. 3, characteristic columns 302, 304, 306 contain multi-dimensional data 118 (FIG. 1). For example, column 302 which contains region characteristics could be drilled down to reveal sub-characteristics, e.g., state characteristics and city characteristics. In another example, column 306 which contains product type characteristics could be drilled down to reveal product families, product types or individual serial numbers.

This drilling down process can be easily and efficiently performed by the MDE (e.g., using editor box 342). For example, using the MDE to drill down column 302 results in a column appearing to the right of 302. This new column may contain new information depicting the break down of the region data into to their corresponding states within the Northern and Southern regions. Thus, the MDE provides users with increased flexibility in adjusting data table 300 according to desired analytical needs.

In other implementations, MDE 342 also provides a “drilling up” function, which is a process that involves collapsing sub-characteristics into higher level (broader) characteristic columns. Thus, sub-characteristics for cities may be drilled up into a single characteristic column representing the entire state or region. Some implementations permit further customization by allowing the user to drag and move the columns and rows via a mouse.

FIG. 4 illustrates process 400 performed by the MDE, which automatically detects the boundary between characteristic region 334 and key figure region 336. FIG. 4 also includes sub-process 426, which distinguishes the characteristic columns from the key figure columns.

Process 400 locates (402) the left-most column in a data table and evaluates (404) whether any empty cells exist within this left-most column. Since all key figure columns contain no empty cells (and some characteristic columns contain empty cells), evaluation process (404) helps pinpoint the areas where the boundary between characteristic region 334 and key figure region 336 may likely exist.

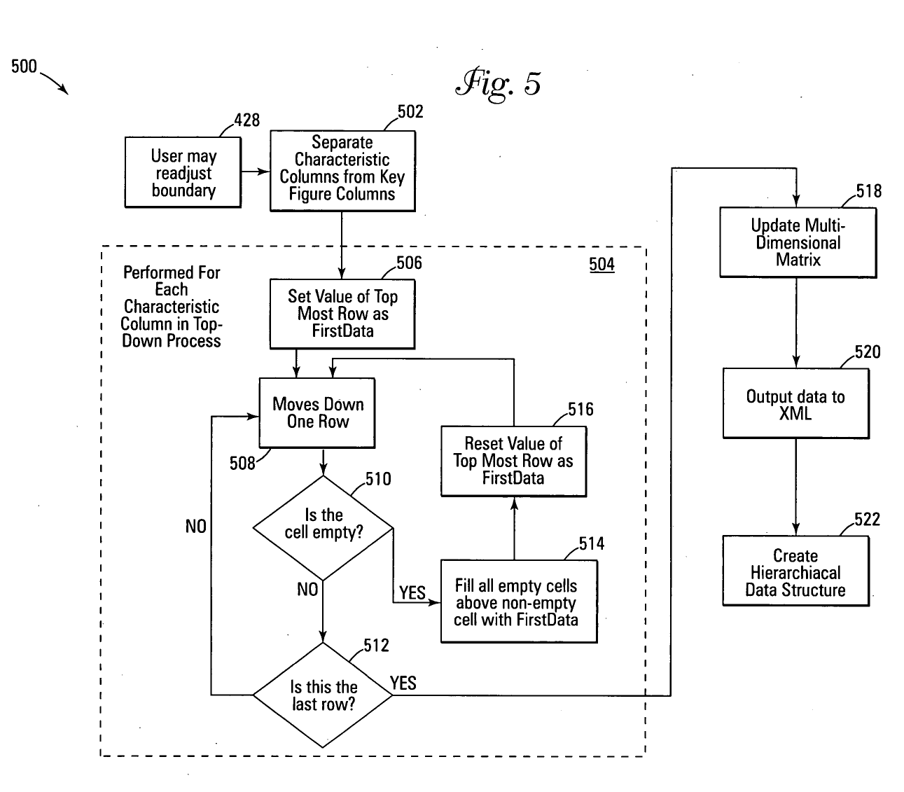

As illustrated by FIG. 3, the left most column corresponds to column 302. If the left most column contains empty cells, then process 400 determines (406) whether it can move over to the right one column. An inability to move over right one column indicates that process (400) has reached the last column. Process 400 categorizes (418) the column as a key figure column. Process (400) automatically determines (410) the boundary to be located to the left of the key figure column. Users may readjust (428) the automatically determined boundary if they so desire. Determining (410) the boundary triggers process 500 which updates the multi-dimensional data warehouse, as described below with respect to FIG. 5.

Where it is possible to move over right one column, process 400 moves (408) over right one column and repeats evaluating (404) for empty rows, determining (406) whether the column is the last column, and moving (408) over right one column until a column with empty cells is found.

Finding a column with no empty cells triggers sub-process 426 which determines which data items are characteristics and which data items are key figures. Referring to FIG. 3 and FIG. 4, sub-process 426 determines (412) whether the data items contained within the left-most column are all numeric data. Examples of numeric data include the calendar year, sales figures, or product inventory.

As shown in FIG. 4, if the data items within the left-most column are not all numeric data, then sub-process 426 categorizes (420) these data items as non-numeric data and calculates (422) a non-numeric percentage. Sub-process 426 uses the non-numeric percentage as a benchmark for determining whether the data item is a characteristic. Non-numeric data may represent salesperson name, region, and product type. The non-numeric percentage is determined by calculating the number of unique data items contained within the left-most column and dividing this number by the total number of data items within the left-most column:

$$Non \text{-} Numeric Percentage = \frac{\# of unique data items within column}{Total \# of data items within entire column} .$$

For example, in FIG. 3, column 306 represents the first column with no empty cells. Assuming that the “A, B, C” pattern continues, rows 324, 330 correspond to “A”, rows 320, 326 correspond to “B”, and rows 322, 328 correspond to “C”. In this example, column 306 contains 3 unique data items: “A”, “B”, and “C”. FIG. 3 only represents a portion of the overall data items for column 306. For the purposes of this example, assume that column 306 contains a sum total of thirty data items. Thus, in this example, the non-numeric percentage is ten-percent.

Sub-process 426 evaluates (424) whether the non-numeric percentage exceeds the non-numeric threshold. The non-numeric threshold may represent any percentage number pre-determined by the end user as likely to produce an accurate result. Columns containing non-numeric percentages below the non-numeric threshold are labeled (426) as characteristic columns. In the example illustrated by FIG. 3, the non-numeric threshold is twenty-percent. Since the non-numeric percentage of ten-percent is below the non-numeric threshold, column 306 is categorized as a characteristic column.

Process 400 then determines (406) whether it is possible to move over right one column. If so, process 400 moves (408) over right one column and evaluates (404) whether there are any empty cells within the column.

Where the non-numeric percentage exceeds (424) the non-numeric threshold, then the column is labeled (418) as key figure column. This means that the preceding column (the column to the left) represents the last characteristic column. Process (400) automatically determines (410) the boundary to be located to the left of the key figure column. Users may also readjust (428) the boundary if they so desire. Determining (410) the boundary triggers process 500 which updates the multi-dimensional data warehouse, as described below with respect to FIG. 5.

Referring back to FIG. 4, where sub-process 426 determines (412) that the data items within the left-most column contains all numeric data, sub-process 426 calculates (414) the numeric percentage. Sub-process 426 uses the numeric percentage as a benchmark for determining whether the data item is a characteristic. Examples of numeric data include the calendar year, sales figures, or aggregate product inventory. Numeric percentage is determined by calculating the number of unique data item contained within the left-most column and dividing this number by the total number of data items within the entire column:

$$Numeric Percentage = \frac{\# of data items within the column}{Total \# of data items within entire column} .$$

Sub-process 426 evaluates (416) whether the numeric percentage exceeds the numeric threshold. Numeric threshold may represent any percentage number pre-determined by the end user as likely to produce an accurate boundary result. In this example, the numeric threshold is ten-percent.

Sub-process 426 evaluates (416) whether the numeric percentage exceeds the numeric threshold. Columns containing numeric percentages above the numeric threshold are labeled (418) as key figure columns. This means that the preceding column (the column to the left) represents the last characteristic column. Process (400) automatically determines (410) the boundary to be located to the left of key figure column. Users may also readjust (428) the boundary if they so desire. Determining (410) the boundary triggers process 500 which updates the multi-dimensional data warehouse, as described below with respect to FIG. 5.

Where the numeric percentage falls below (416) the numeric threshold, the column is labeled (426) as a characteristic column. Process 400 determines (406) whether it is possible to move over right one column, and if possible, process 400 moves (408) over right one column and evaluates (404) whether there are any empty cells within the column.

Sub-process 426 may be either over-inclusive or under-inclusive. Sub-process 426 is over-inclusive when it includes key figure columns within characteristic region 334. Sub-process 426 is under-inclusive when it determines the boundary to exclude characteristic columns from characteristic region 334. An additional advantageous function permits users to modify the results of automatic process 400. In this regard, it is useful to have a visual representation of the boundary to provide a means for users to evaluate the end result produced by sub-process 426. As illustrated in FIG. 3, the boundary between characteristic region 334 and key figure region 336 is visually apparent. Thus, users may further customize data table 300 by modifying the end results through adjusting the boundary location between characteristic region 334 and key figure region 336.

After process 400 determines (410) and readjusts (428) the boundary (where necessary), process 500 updates the multi-dimensional data warehouse. Referring to FIG. 5, process 500 involves separating (502) characteristic columns from key columns, updating the multi-dimensional matrix (518), outputting (520) multi-dimensional data in XML format and creating (522) a new hierarchical data structure. Process 500 also includes sub-process 504 which fills the empty rows in each column with the corresponding characteristic. Sub-process 504 begins the filling process from the top-most row to the bottom-most row in each column.

Process 500 separates (502) characteristic region 334 (FIG. 3) from key figure region 336. Separation (502) uses last characteristic column 306 as the boundary between these two regions. Last characteristic column 306 is determined via automatic detection process 400. After separating (502) characteristic columns from key columns, process 500 performs sub-process 504 which fills, in a top-down manner (as described above), each of the empty rows located within the columns with their corresponding characteristics.

Sub-process (504) starts at the top-most row of each column, and it sets (506) the data item contained in that top-most row as FirstData. Sub-process 504 moves (508) down one row and determines (510) whether the cell is empty. If the cell is not empty, then sub-process 504 determines (512) whether the cell represents the last row. The last row of a column is found where sub-process 504 cannot move down a row. A finding of the last row triggers multi-dimensional matrix updating process 518.

Referring back to FIG. 5, determining (510) that a cell is empty triggers the filling (514) of the empty cell with the data item which was set (506) as FirstData. FirstData is then reset (516) to be the data item contained in the non-empty cell which was located by determining process (510). Sub-process 504 repeats moving (508) down one row, determining (510) whether the cell is empty, determining (512) whether the cell represents the last row, and where appropriate, filling (514) the empty cell with FirstData.

Filling sub-process (504) satisfies part of matrix updating process (518). In other implementations, matrix updating process (518) may include the aggregation of relevant figures (e.g. total sales figures for each region).

Process 500 outputs (520) the multi-dimensional data to an external network device or to a local computer, and creates (522) a new hierarchical data structure. In some implementations the external program may be written in XML format. Other formats may include common-separated value files (CSV), tab-separated value files (TSV), or Excel. Still other implementations may write the data directly into a local file.

The MDE, described herein, is not limited to use with the hardware and software described herein; they may find applicability in any computing or processing environment and with any type of machine that is capable of running machine-readable instructions, such as a computer program.

MDE may be implemented in digital electronic circuitry, or in computer hardware, firmware, software, or in combinations thereof. The MDE may be implemented via a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of processes 400 and 500 can be performed by one or more programmable processors executing a computer program to perform the functions of processes 400 and 500. The method steps can also be performed by, and processes 400 and 500 can be implemented as special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer include a processor for executing instructions and one or more memory devices for storing instructions and data. Generally, a computer will also include, or be operatively coupled to receive data from, or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

MDE can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the record extractor, or any combination of such back-end, middleware, or front-end components. The components of the system can be interconnected by any form or medium of digital data communication, e.g., a communication network. Examples of communication networks include a local area network (“LAN”) and a wide area network (WAN”), e.g., the Internet.

The computing system can include clients and servers. A client and server are generally remote from each other and typically interact through a communication network. The relationship of client and server arises by virtue of computer programs running on respective computers and having a client-server relationship to each other.

Processes 400 and 500 are not limited to the implementations set forth herein. For example, the steps of processes 400 and 500 can be rearranged and/or one or more such steps can be omitted to achieve similar results. MDE may link to existing business models, thereby providing enhanced flexibility. Processes 400 and 500 may be fully automated, meaning that they operate without user intervention, or interactive, meaning that all or part of each process includes some user intervention.

The MDE, described herein, is not limited to the specific formats set forth above. Elements of different implementations may be combined to form another implementation not specifically set forth above. Other implementations not specifically described herein are also within the scope of the following claims.

1. A method comprising:
obtaining a first position of a first data item in a data table;
obtaining a second position of a second data item in the data table;
comparing the first position with the second position;
inferring a relationship between the first data item and the second data item based upon comparing the first position with the second position; and
updating the data table based on the relationship.

2. The method of claim 1, wherein the first and second data items comprise multi-dimensional data, wherein the multi-dimensional data comprises hierarchical data.

3. The method of claim 1, further comprising associating the first data item with a characteristic, where the characteristic represents a classification on which a key figure is based.

4. The method of claim 3, wherein the key figure represents quantifiable values.

5. The method of claim 1, wherein the relationship can be inferred horizontally and vertically.

6. The method of claim 1, wherein updating the data table further comprises:
detecting a boundary between a characteristic column and a key figure column;
filling an empty cell located within the characteristic columns with a characteristic located above; and
outputting the multi-dimensional data over a network device or to a local location.

7. The method of claim 6, wherein filling the empty cell is performed from top to bottom.

8. The method of claim 6, wherein the multi-dimensional data is outputted in XML format.

9. A method for detecting a boundary between a characteristic region and a key figure region, comprising:
locating a first column of a data table that contains an empty cell;
determining whether a plurality of data items contained within the first column correspond to numeric data items or correspond to non-numeric data items;
calculating a criterion using the plurality of data items contained within the first column; and
determining whether the first column corresponds to a characteristic column or to a key figure column based on the criterion.

10. The method of claim 9, wherein locating the first column of the data table comprises determining whether the first column represents a last characteristic column of the data table.

11. The method of claim 10, wherein the last characteristic column of the data table comprises the boundary between the characteristic region and the key figure region.

12. The method of claim 11, wherein the method is automatically performed.

13. The method of claim 12, wherein the boundary is represented graphically.

14. The method of claim 13, wherein the boundary is adjustable by an end user.

15. The method of claim 9, wherein the criterion corresponds to a numeric percentage for the numeric data item that is greater than a numeric threshold, and to a non-numeric percentage for the non-numeric data item that is greater than a non-numeric threshold.

16. The method of claim 15, wherein the numeric threshold and the non-numeric threshold are pre-determined by the end user.

17. The method of claim 15, wherein the numeric threshold is ten-percent and the non-numeric threshold is twenty-percent.

18. The method of claim 15, wherein the numeric percentage is calculated by dividing a number of unique data items contained within the first column by a sum total of data items contained within the first column.

19. The method of claim 15, wherein the non-numeric percentage is calculated by dividing a number of unique data items contained within the first column by a sum total of data items within the first column.

21. A computer program product, tangibly embodied in an information carrier, the computer program product being operable to cause a data processing apparatus to:
obtain a first position of a first data item in a data table;
obtain a second position of a second data item in the data table;
compare the first position with the second position;
infer a relationship between the first data item and the second data item based upon comparing the first position with the second position; and
update the data table based on the relationship.

22. A computer program product, tangibly embodied in an information carrier, the computer program product being operable to cause a data processing apparatus to:
locate a first column of a data table that contains an empty cell;
determine whether a plurality of data items contained within the first column corresponds to numeric data items or corresponds to non-numeric data items;
calculate a criterion using the plurality of data items contained within the first column; and
determine whether the first column corresponds to a characteristic column or to a key figure column based on the criterion.
